(19) United States
(12) Patent Application Publication
(10) Pub. No.: US 2023/0169359 A1
(43) Pub. Date: Jun. 1, 2023

(54) MODEL MANAGEMENT SYSTEM, METHOD, AND STORAGE MEDIUM

(71) Applicant: Hitachi, Ltd., Tokyo (JP)

(72) Inventors: Kazuhiko MIZUNO, Tokyo (JP); Masayuki SAKATA, Tokyo (JP); Yohsuke ISHII, Tokyo (JP)

(21) Appl. No.: 17/901,822

(22) Filed: Sep. 1, 2022

(30) Foreign Application Priority Data
Nov. 26, 2021 (JP) 2021-192520

(51) Int. Cl. G06N 5/02

(52) U.S. Cl. CPC G06N 5/022

(57) ABSTRACT

A system managing a model for predicting processing performance of software configuring an application in a deployment destination includes: a model management table that stores a first common model that is a prediction model able to be commonly used for prediction of processing performance of software of a same type; a data management table that stores first configuration information representing a configuration of a deployment destination of software used for learning when the first common model is generated; a configuration comparison unit that extracts a difference between second configuration information representing a configuration of a deployment destination of target software comprising a prediction target, and the first configuration information; and a model generation unit that generates a prediction model through learning using configuration information acquired by adding the difference to the first configuration information and sets the prediction model as a second common model that is a new common model.

### CROSS-REFERENCE TO RELATED APPLICATIONS

This application is based upon and claims the benefit of priority from Japanese Patent Application No. 2021-192520 filed in Japan Patent Office on Nov. 26, 2021, the contents of which are hereby incorporated by reference.

### BACKGROUND

The present disclosure relates to a technology for managing a prediction model applied to software configuring an application.

As a method for providing an IT infrastructure realized by an application, there is a provision method called a multi-cloud or a hybrid cloud. In the multi-cloud or the hybrid cloud, sites of a plurality of environments including a cloud environment are used in combination. An application is configured using one or more pieces of software, and the application or each piece of the software is arranged at an appropriate site. At that time, there are also cases in which sites of different types such as a public cloud, a private cloud, and an on-premises are combined.

For example, a configuration, in which a search system application is configured by software implementing a web server and software implementing an SQL server managing a database, and the application or each piece of the software is deployed in an on-premises or public cloud, may be considered. Furthermore, a configuration, in which a data collection application collecting IoT data accumulated in a database is deployed in edges, may be considered.

In order to satisfy processing performance (hereinafter, also referred to as “requested processing performance”) requested by an application, each piece of software needs to satisfy each requested processing performance. For example, the processing performance is represented using an execution time, a throughput, and the like. The processing performance changes in accordance with an environment of a deployment destination of an application. A manager who performs maintenance and management of an information processing infrastructure including an application (hereinafter, also referred to as an “IT infrastructure manager”) deploys each piece of software of the application in a site having an appropriate environment satisfying requested processing performance of each piece of the software. For example, a container of an appropriate amount of resources for each piece of software is prepared, and each piece of the software is deployed in the container. For example, the amount of resources described here is the number of CPU cores, an amount of memory, and the like.

Processing performance that can be acquired by a container changes in accordance with an amount of resources assigned to the container. Thus, the IT infrastructure manager predicts processing performance exhibited by a container using the amount of resources as a parameter and determines a deployment destination of software and an amount of resources of the container. An IT infrastructure manager generates a prediction model (hereinafter simply referred to as a “model” as well) for calculating a prediction value of processing performance using an amount of resources as an input parameter and uses the prediction model for prediction thereof. For example, the prediction model may be acquired through machine learning or deep learning or may be a regressive type or the like. Each model is generated in accordance with a deployment destination of an application and a type of application on the basis of configuration information representing a configuration of resources that can be used in each site and operating information representing an operating state of resources at the time of executing software in the site in the past.

In U.S. Patent Publication No. US2019/0377897, a technology for determining whether a query relates to data that can be used for resources of a public cloud or data that can be used for resources of a private cloud and selecting whether the public cloud model is used or the private cloud mode is used for the process of the query in accordance with a result of the determination has been disclosed.

### SUMMARY

There are cases in which, in accordance with elapse of time, the environment of a site changes, and prediction accuracy of the model is lowered. For this reason, in order to manage a model such that high prediction accuracy is maintained, it is requested to update the model as necessary. In updating a model, new matrix information, learning data, and the like need to be prepared or collected, and thus the number of processes and the cost increase.

When the number of applications or the scale of each application increases, the number of pieces of software configuring the application also increases, and the number of models applied to the software increases in accordance therewith. When the number of models increases, the number of processes and the cost required for updating the models increase as well.

One object of the present disclosure is to provide a technology enabling efficient management of a prediction model used for evaluating processing performance of software configuring an application.

According to one aspect of the present disclosure, there is provided a model management system managing a prediction model for predicting processing performance of software configuring an application in a deployment destination, the model management system including: a model management table configured to store a first common model that is a prediction model able to be commonly used for prediction of processing performance of software of a same type; a data management table configured to store first configuration information representing a configuration of a deployment destination of software used for learning when the first common model is generated; a configuration comparison unit configured to extract a difference between second configuration information representing a configuration of a deployment destination of target software, which is a prediction target, and the first configuration information; and a model generation unit configured to generate a prediction model through learning using configuration information that is acquired by adding the difference to the first configuration information and set the prediction model as a second common model that is a new common model.

According to one aspect of the present disclosure, a prediction model used for evaluating processing performance of software configuring an application can be efficiently managed.

### BRIEF DESCRIPTION OF THE DRAWINGS

FIG. 1 is a block diagram illustrating a configuration example of a hybrid cloud according to a first embodiment;

FIG. 2 is a block diagram illustrating an internal configuration example of an on-premises system according to the first embodiment;

FIG. 3 is a block diagram illustrating an internal configuration example of a public cloud system according to the first embodiment;

FIG. 4 is a block diagram illustrating an internal configuration example of a management system according to the first embodiment;

FIG. 5 is a diagram illustrating a configuration example of an operating configuration information management table according to the first embodiment;

FIG. 6 is a diagram illustrating a configuration example of an application catalog management table according to the first embodiment;

FIG. 7 is a diagram illustrating a configuration example of a model management table according to the first embodiment;

FIG. 8 is a diagram illustrating a configuration example of a data management table according to the first embodiment;

FIG. 9 is a diagram illustrating a configuration example of a model update table according to the first embodiment;

FIG. 10 is a diagram illustrating a configuration example of a common model generation history management table according to the first embodiment;

FIG. 11 is a diagram illustrating a configuration example of a screen of an operating portal according the first embodiment;

FIG. 12 is a diagram illustrating an overview of a prediction model that is assumed in the first embodiment;

FIG. 13 is a diagram illustrating an overview of an application assumed in the first embodiment;

FIG. 14 is a diagram illustrating an overview of a process relating to commonization of a prediction model according to the first embodiment;

FIG. 15 is a flowchart illustrating a series of flows of a process relating to commonization of a prediction model according to the first embodiment;

FIG. 16 is a flowchart illustrating an initial registration process of a common model according to the first embodiment;

FIG. 17 is a flowchart illustrating a model generation process applied to an application according to the first embodiment;

FIG. 18 is a diagram illustrating an overview of a process relating to commonization of a model according to a second embodiment;

FIG. 19 is a diagram illustrating a configuration example of a model management table according to the second embodiment;

FIG. 20 is a diagram illustrating a configuration example of a screen of an operating portal according to the second embodiment;

FIG. 21 is a flowchart illustrating a series of flows of a commonization process of prediction models according to the second embodiment;

FIG. 22 is a flowchart illustrating a model registration process according to the second embodiment; and

FIG. 23 is a flowchart illustrating a model reorganization process according to the second embodiment.

### DETAILED DESCRIPTION OF THE EMBODIMENT

Hereinafter, embodiments of the present invention will be described with reference to the drawings.

### First Embodiment

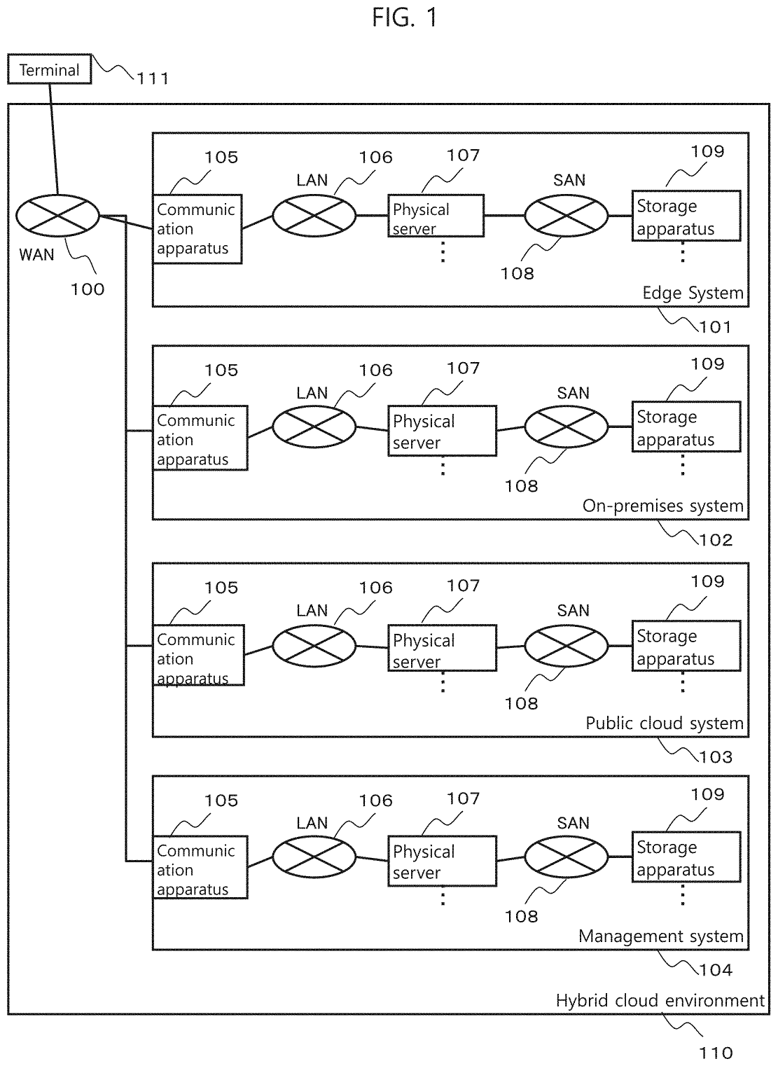

FIG. 1 is a block diagram illustrating a configuration example of a hybrid cloud according to a first embodiment.

Referring to FIG. 1, in a hybrid cloud environment 110, an edge system 101, an on-premises system 102, a public cloud system 103, and a management system 104 are included. Hereinafter, the on-premises system 102 maybe referred to as an on-pre system 102, and the public cloud system 103 may be referred to as a pub-cloud system 103.

The hybrid cloud environment 110 is a computing environment in which computer systems of sites of a plurality of environments including cloud environments are combined. In this embodiment, the edge system 101, the on-premises system 102, and the public cloud system 103 are combined. The edge system 101 is a computer system disposed at a place near a user or a device. The on-premises system 102 is a computer system managed by a user. The public cloud system 103 is a computer system provided on a public cloud.

Each of the edge system 101, the on-premises system 102, and the public cloud system 103 is configured to include a communication apparatus 105, a LAN (Local Area Network) 106, a physical server 107, a SAN (Storage Area Network) 108, and a storage apparatus 109 as a common basic configuration. The communication apparatus 105 is an apparatus that enables the physical server 107 to communicate with the outside via a WAN (Wide Area Network) 100. The physical server 107 is connected to the communication apparatus 105 via the LAN 106. In addition, the physical server 107 is connected to the storage apparatus 109 via the SAN 108. The physical server 107 is a computer that performs a process of software and records data in the storage apparatus 109 and acquires data from the storage apparatus 109 in accordance with the process.

The management system 104 is a computer system that manages the hybrid cloud environment 110, each application mounted therein, and software configuring each application. The application is composed of one or more pieces of software. The management system 104 may be mounted in any environment.

Here, although a configuration in which one edge system 101, one on-premises system 102, and one public cloud system 103 are included is illustrated, a configuration including a plurality of all the systems may be employed.

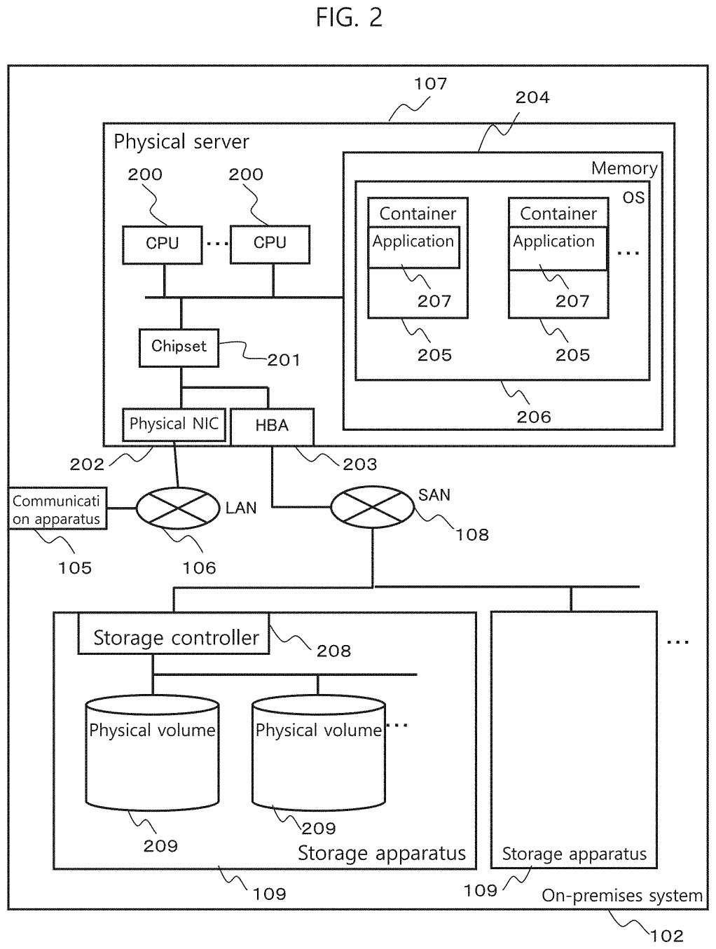

FIG. 2 is a block diagram illustrating an internal configuration example of the on-premises system 102 according to the first embodiment.

Referring to FIG. 2, in the on-premises system 102, the physical server 107 includes a CPU (Central Processing Unit) 200, a chip set 201, a physical NIC (Network Interface Card) 202, an HBA (Host Bus Adapter) 203, and a memory 204. On an OS (Operating System) 206 arranged in the memory 204, a container 205 in which an application 207 is deployed is provided.

The CPU 200 is a processor that reads the application 207 (hereinafter also referred to as “application 207”) from the memory 204 and performs a process thereof. The chip set 201 is abridge circuit that connects apparatuses arranged inside the physical server 107. The physical NIC 202 is an interface card that enables a physical connection to the LAN 106 . The HBA 203 is an interface card that provides a physical connection for realizing communication with the storage apparatus 109 via the SAN 108.

The storage apparatus 109 includes a storage controller 208 and a physical volume 209. The physical volume 209 is a physical storage area provided by a storage device such as a hard disk. A plurality of storage devices are mounted in the storage apparatus 109, and the storage controller 208 integrates physical storage areas of the plurality of storage devices and provides the integrated area as a logical storage area.

The edge system 101 has an internal configuration that is identical or similar to the on-premises system 102 illustrated in FIG. 2. The edge system 101 is mainly used for the purpose of acquisition, storage, and the like of IoT data of a factory and the like.

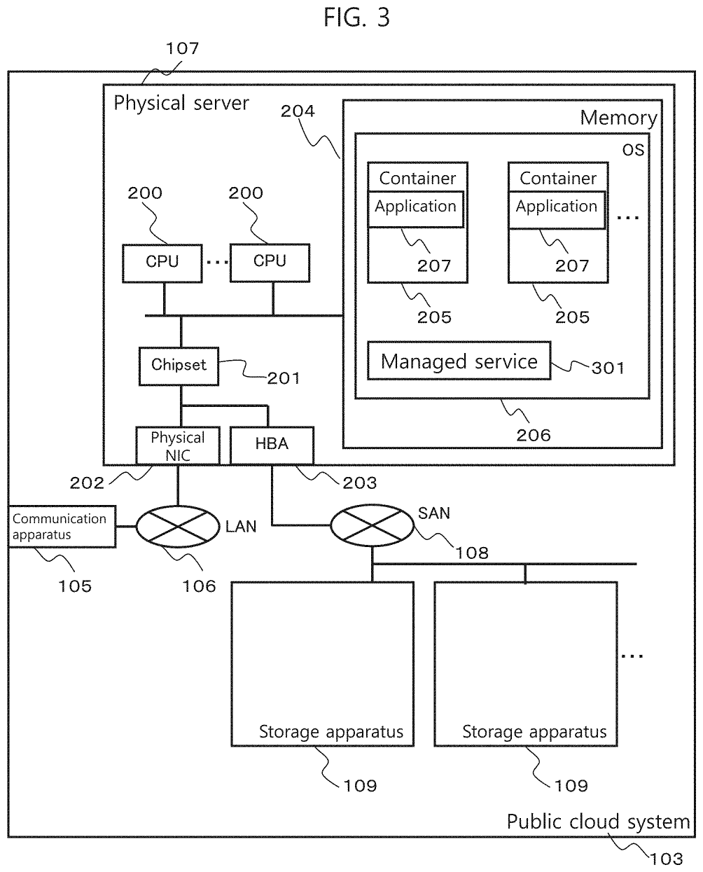

FIG. 3 is a block diagram illustrating an internal configuration example of the public cloud system 103 according to the first embodiment.

Referring to FIG. 3, in the public cloud system 103, a managed service 301 is arranged on the OS 206, which is different from the on-premises system 102 . The managed service 301 is software that realizes a unique service provided by a cloud service provider on the environment of the public cloud.

A user can use this managed service 301 as his or her application or a part thereof.

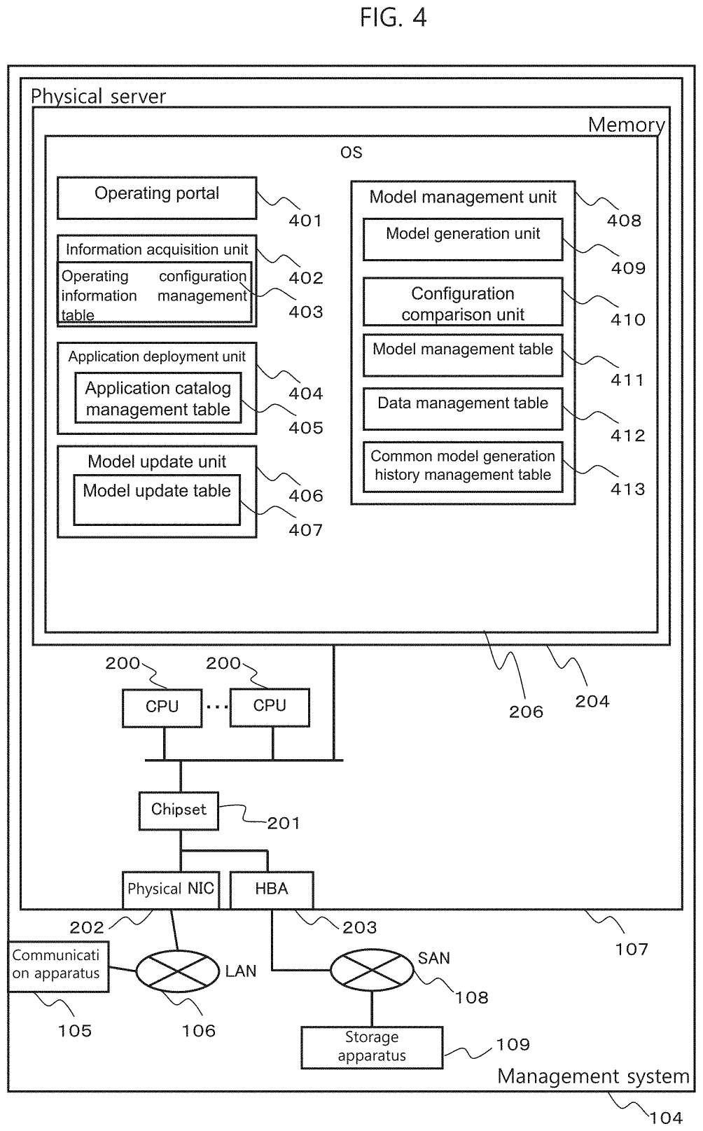

FIG. 4 is a block diagram illustrating an internal configuration example of the management system 104 according to the first embodiment.

Referring to FIG. 4, in the management system 104, an operating portal 401, an information acquisition unit 402, an application deployment unit 404, a model update unit 406, and a model management unit 408 are arranged as software operating on the OS 206. The information acquisition unit 402 includes an operating configuration information management table 403. The application deployment unit 404 includes an application catalog management table 405. The model update unit 406 includes a model update table 407. The model management unit 408 includes a model generation unit 409 and a configuration comparison unit 410 as internal software and includes a model management table 411, a data management table 412, and a common model generation history management table 413.

The operating portal 401 provides an operation screen for generating or updating a common model of software configuring an application.

The information acquisition unit 402 acquires configuration information representing an amount of physical or logical resources of a computer provided for software and operating information representing an operation of a computer in each site (an on-premises system, a public cloud system, and an edge) of the hybrid cloud environment and registers the acquired information in the operating configuration information management table 403. As sites of the hybrid cloud environment, there are an on-premises system, a public cloud system, an edge system, and the like.

The operating configuration information management table 403 is a table in which configuration information representing an amount of resources allocated to software of an application operating in each site, operating information such as a CPU utilization rate according to execution of software, and processing performance including a processing time and charging information of an application are registered.

The configuration information is information representing a configuration of resources allocated to software and can be acquired from deployment configuration information configured from a manifest file or the like used in a case in which software is deployed in a site. The operating information is information representing a degree of an operation of resources allocated to software and, for example, can be acquired using an OSS (Open Source Software) tool. The processing time is information representing a time required for performing a predetermined process. The processing time may be calculated by hooking communication between containers, or a time until a result is returned for an input may be measured. The charging information is information representing an amount of money charged for use of resources. By acquiring a charge system representing a price for each amount of resources in advance, the amount of money may be calculated on the basis of an amount of used resources and the charge system.

The application deployment unit 404 deploys an application 207 or software in each site. In a case in which an application or software is deployed on a container, by generating a manifest file that is configuration information of a deployment configuration, deployment may be performed automatically, for example, using a general tool. A deployment destination of the application 207 or software is not limited to a container and may be a virtual machine or a server (including a physical server and a server provided by the managed service).

The application catalog management table 405 is a table in which a manifest file, a deployment tool, and an image storage destination are registered. By generating a template in advance, the application catalog management table 405 may be updated in accordance with determination based on a prediction result acquired using the prediction model.

The model update unit 406 performs update of a common model as necessary. For example, this unit acquires the operating information and the configuration information used for learning the common model, which has been registered by the model generation unit 409, and operating information and configuration information in each site and checks whether there is a change in each piece of the information. In a case in which there is a change in each piece of the information, the model update unit 406 updates the common model through relearning based on the operating information and the configuration information in each site and registers a new common model in the model update table 407.

The model update table 407 is a table storing various kinds of information about prediction models including the common model. For example, in the model update table 407, input information, output information, operating information used for learning, and configuration information of a prediction model are registered for each piece of software. In addition, in the model update table 407, commonization/non-commonization of a model can be checked using a commonization flag. The commonization flag being “1” represents a common model that is communized through relearning. The commonization flag being “0” represents a prediction model that has been newly registered and has not been applied to anything.

The model management unit 408 generates, applies, and manages a common model applied to the application 207.

The model generation unit 409 generates a common model by performing relearning of the common model applied to software configuring the application 207 on the basis of a result acquired by the configuration comparison unit 410 and registers the generated common model in the model management table 411. In addition, the model generation unit 409 registers relearned details in the common model generation history management table 413. When a difference that is a result of the process performed by the configuration comparison unit 410 relates to resources in relearning of the common model, the model generation unit 409 performs handling by acquiring information used for learning (learning data) when the common model is generated and narrowing this learning data. Here, the narrowing of this learning data is control according to a result of the process performed by the configuration comparison unit 410 described above. In addition, when a difference that is a result of the process performed by the configuration comparison unit 410 relates to the managed service 301, the model generation unit 409 performs handling on the basis of the common model and a generation history of the common model in the on-premises system 102.

The configuration comparison unit 410 compares the configuration information of the site (the on-premises system 102, the public cloud system 103, and the edge system 101) in which the application 207 is deployed with the configuration information of the site used when the common model is generated and extracts a difference of the configuration information.

The model management table 411 is a table for registering input information, output information, operating information used for learning, and configuration information of a prediction model for each of one or more pieces of software of the used application and managing the information. In addition, in the model management table 411, whether or not a prediction model is communized is represented using a commonization flag. When the commonization flag is “1”, it represents a state in which a commonization model has been registered through relearning. On the other hand, when the commonization flag is “0”, it represents a state in which a prediction model has been newly registered (a model that has not been used to any).

The data management table 412 is a table used for registering and managing configuration information and operating information used when a common model is learned.

The common model generation history management table 413 is a table for registering and managing histories such as relearning, new generation, update, and the like of a common model according to deployment of software.

Here, details of the configuration of each table and the process of each unit will be sequentially described.

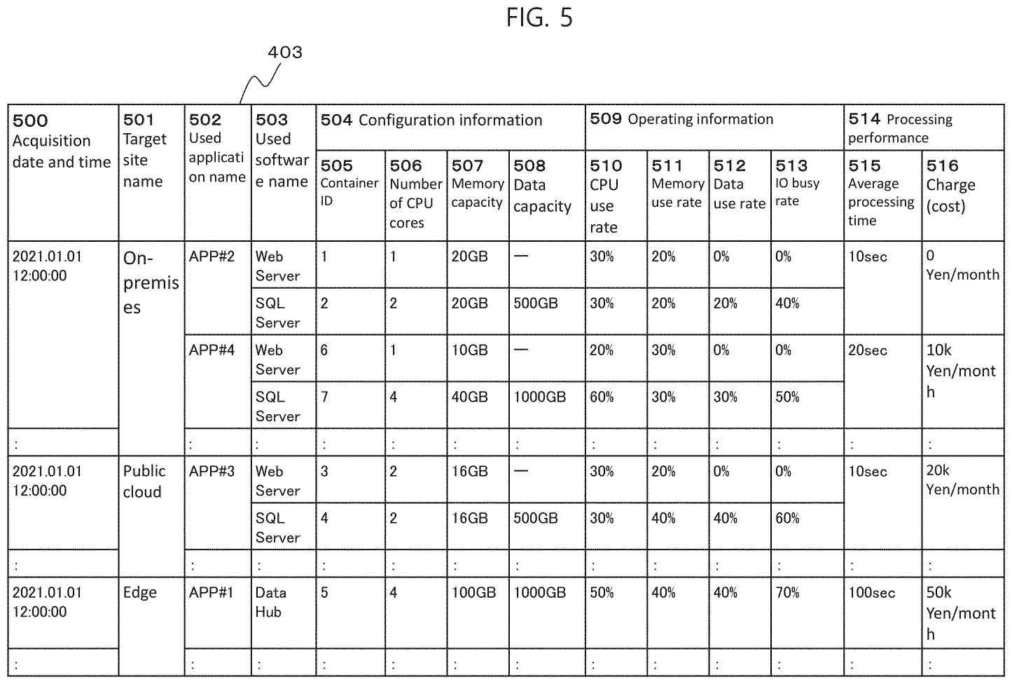

FIG. 5 is a diagram illustrating a configuration example of the operating configuration information management table 403 according to the first embodiment. In the operating configuration information management table 403, information relating to a configuration and an operating state of each piece of software of each application 207 deployed in each site are recorded. The configuration is information set when the software is deployed. The operating state is information having a possibility of being changed, and a latest value is stored.

Referring to FIG. 5, in the operating configuration information management table 403, an acquisition date and time 500, a target site name 501, a used application name 502, a used software name 503, configuration information 504, operating information 509, and processing performance 514 are recorded in association with each other.

The acquisition date and time represents a date and time 500 at which information has been acquired. The target site name 501 represents a site name of a site that is a target. The used application name 502 represents a name of an application 207 that is deployed in the site. The used software name 503 represents a name of each piece of software configuring the corresponding application 207. The configuration information 504 is information that represents a configuration of a container in which the corresponding software is deployed and includes a container ID 505, the number of CPU cores 506, a memory capacity 507, and data capacity 508 of the container. The operating information 509 is information that represents an operating state of the software in the container and includes a CPU utilization rate 510, a memory utilization rate 511, a data utilization rate 512, and an IO busy rate 513. The processing performance 514 is information that representing processing performance of software in a corresponding container and includes an average processing time 515 and charge (cost) 516.

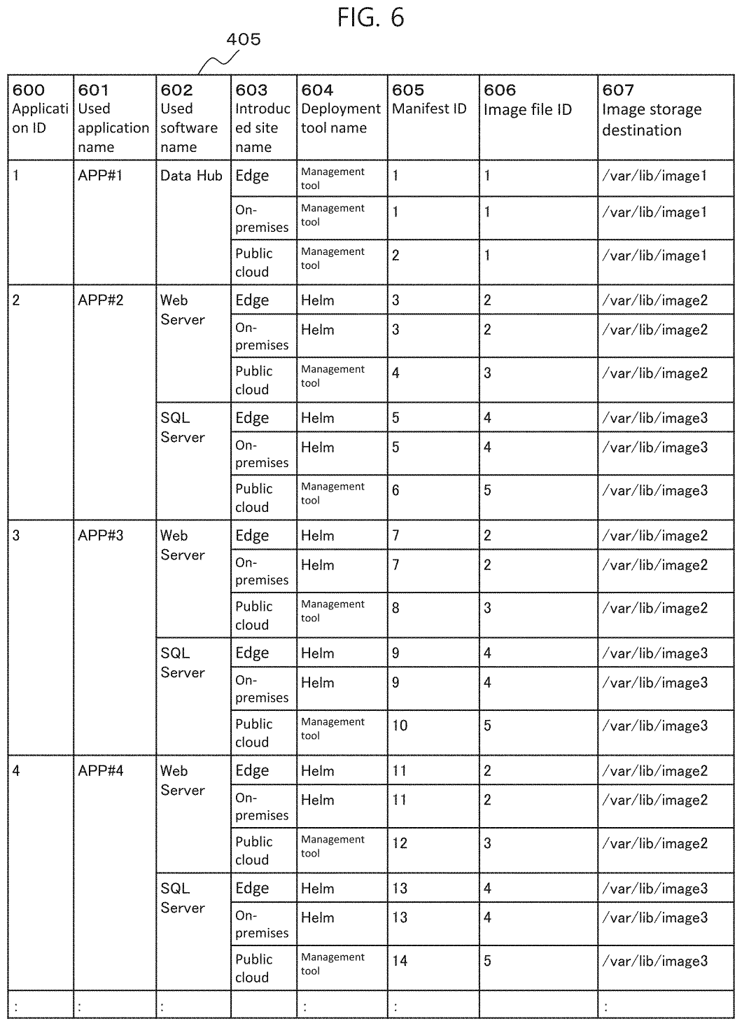

FIG. 6 is a diagram illustrating a configuration example of the application catalog management table 405 according to the first embodiment. In the application catalog management table 405, catalog information used for introducing each piece of software of each application 207 into the site is registered.

Referring to FIG. 6, in the application catalog management table 405, an application ID 600, a used application name 601, a used software name 602, an introduction site name 603, a deployment tool name 604, a manifest ID 605, an image file ID 606, and an image storage destination 607 are recorded in association with each application 207.

The application ID 600 is identification information of the application 207. The used application name 601 represents a name of the application 207. The used software name 602 represents a name of the software. The introduction site name 603 represents a site name of a site in which the software is introduced. The deployment tool name 604 represents a name of a deployment tool used for deploying the software in the site. The manifest ID 605 is identification information of a manifest file of a case in which the software is deployed in the site. The image file ID 606 is identification information of an image file used in a case in which the software is deployed in the site. The image storage destination 607 represents a storage place of an image file used in a case in which the software is deployed in the site.

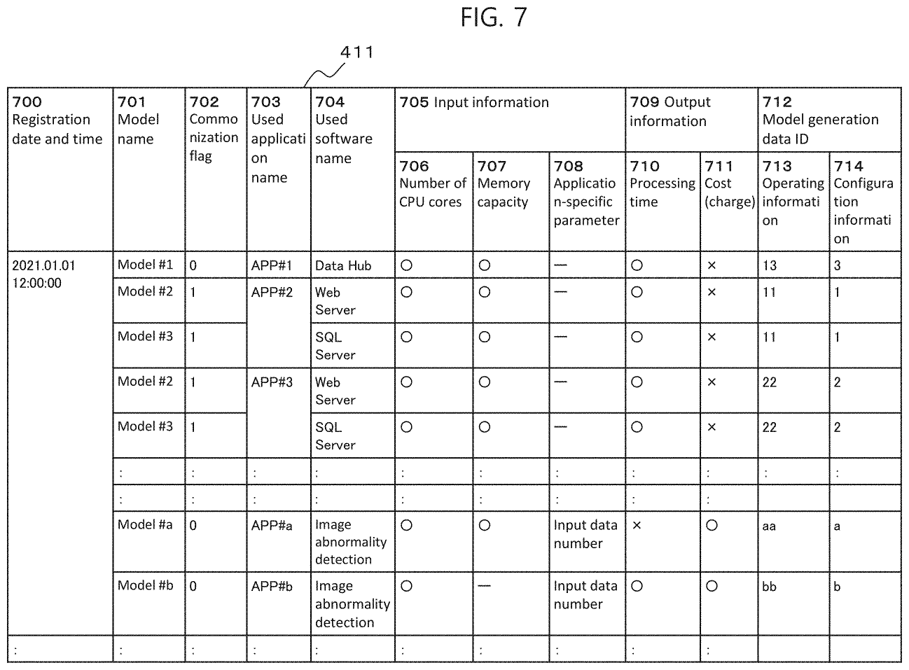

FIG. 7 is a diagram illustrating a configuration example of the model management table 411 according to the first embodiment. In the model management table 411, information about each of prediction models including the commonization model is recorded.

Referring to FIG. 7, in the model management table 411, a registration date and time 700, a model name 701, a commonization flag 702, a used application name 703, a used software name 704, input information 705, output information 709, and a model generation data ID 712 are recorded in association with each other.

The registration date and time 700 represents a date and time at which a corresponding prediction model is registered. The model name 701 represents a name of the prediction model. The commonization flag 702 is a flag that represents whether or not the prediction model is a common model. The used application name 703 represents a name of the application 207 to which the prediction model is applied. The used software name 704 represents a name of software to which the prediction model is applied. The input information 705 is information input to the prediction model as descriptive variables and includes the number of CPU cores 706, a memory capacity 707, and an application-specific parameters 708. The application-specific parameters represent input information such as the number of pieces of input data of the application 207, and a plurality of pieces of input information is assumed. The output information 709 is information that is output from the prediction model as objective variables and includes a processing time 710 and a cost (charge) 711. The model generation data ID 712 is identification information of data used when the prediction model is generated and includes operating information 713 and configuration information 714.

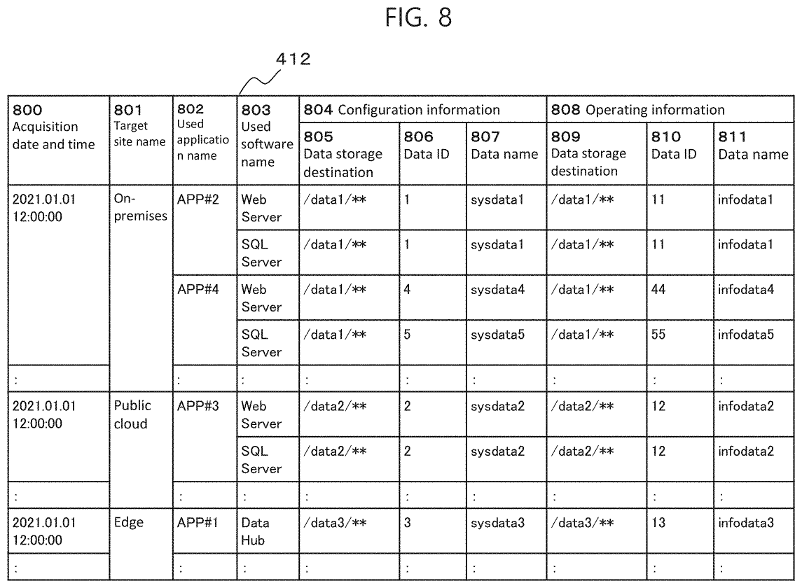

FIG. 8 is a diagram illustrating a configuration example of the data management table 412 according to the first embodiment. In the data management table 412, management information relating to the configuration information and the operating information of each piece of software deployed in each site.

Referring to FIG. 8, in the data management table 412, an acquisition date and time 800, a target site name 801, a used application name 802, a used software name 803, configuration information 804, and operating information 808 are recorded in association with each other.

The acquisition date and time 800 represents a date and time at which the information has been acquired. The target site name 801, the used application name 802, and the used software name 803 respectively represents names of a site, an application 207, and software that are targets of the information. The configuration information 804 is management information about configuration information and includes a data storage destination 805, a data ID 806, and a data name 807. The operating information 808 is management information relating to operating information and includes a data storage destination 809, a data ID 810, and a data name 811.

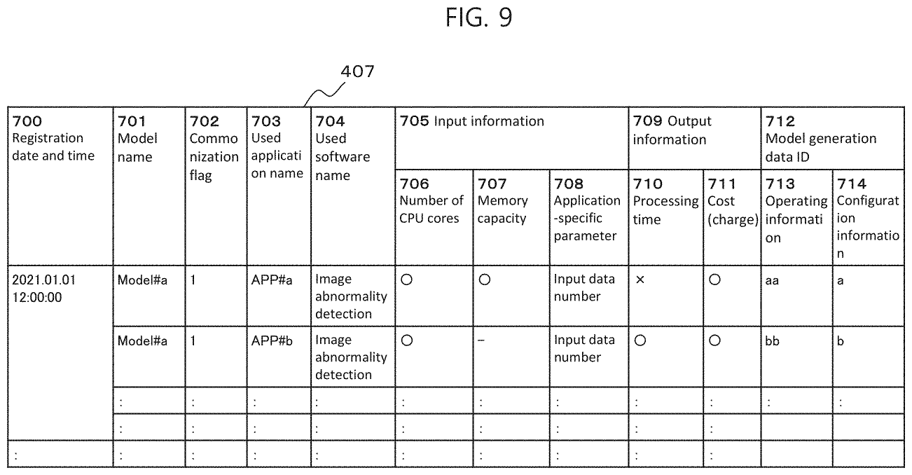

FIG. 9 is a diagram illustrating a configuration example of the model update table 407 according to the first embodiment. In the model update table 407, information about each of updated prediction models is recorded. Referring to FIG. 9, the configuration of the model update table 407 is the same as the configuration of the model management table 411 illustrated in FIG. 7.

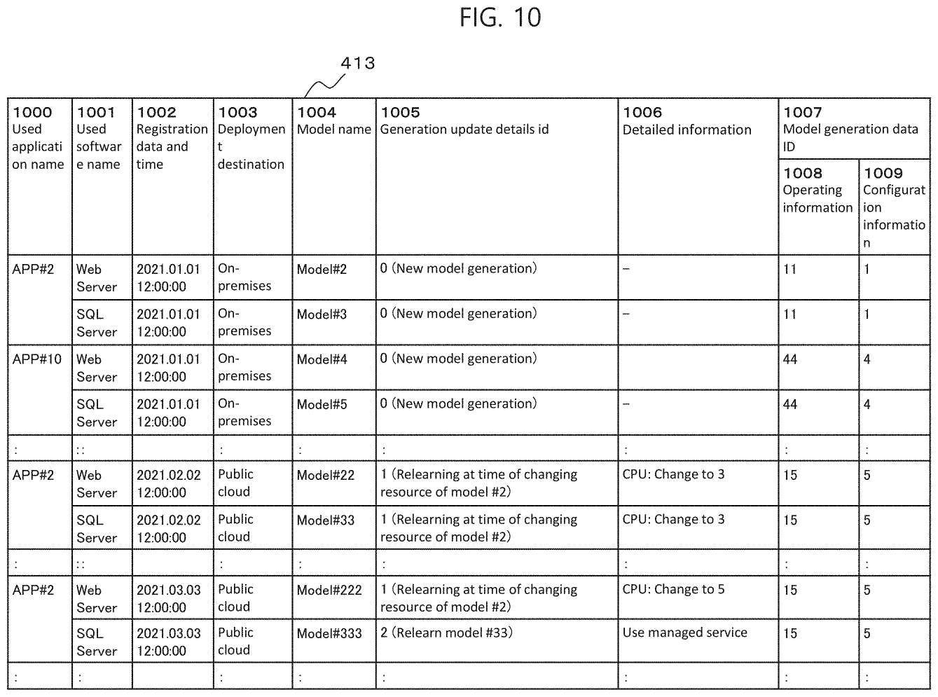

FIG. 10 is a diagram illustrating a configuration example of the common model generation history management table 413 according to the first embodiment. In the common model generation history management table 413, information about each generated common model is registered.

Referring to FIG. 10, in the common model generation history management table 413, for each common model, a used application name 1000, a used software name 1001, a registration date and time 1002, a deployment destination 1003, a model name 1004, a generated update details ID 1005, detailed information 1006, and a model generation data ID 1007 are recorded.

The used application name 1000 represents a name of an application 207 to which a corresponding common model is applied. The used software name 1001 represents a name of software to which the common model is applied. The registration date and time 1002 represents a date and time at which the common model is registered. The deployment destination 1003 represents a site in which software to which the common model is applied is deployed. The model name 1004 represents a name of the common model. The generated update details ID 1005 is information relating to generation or update of the common model. For example, in the case of “0”, it represents “new model generation”, in the case of “1”, it represents “a relearned model by changing resources”, and in the case of “2”, it represents “relearning (update) of the model”. The detailed information 1006 is detailed information of generated update details of the common model. The model generation data ID 1007 is identification information of data used when the prediction model is generated and includes identification information of each of the operating information 1008 and the configuration information 1009.

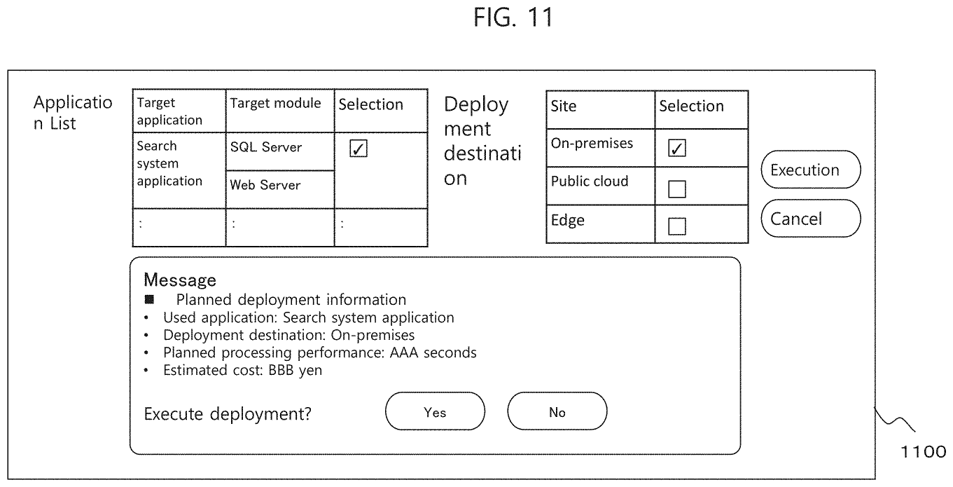

FIG. 11 is a diagram illustrating a configuration example of a screen of an operating portal 401 according the first embodiment. This management system 104 provides various kinds of user interfaces for an operator (IT infrastructure manager) operating the terminal 111 using the operating portal 401. A screen 1100 illustrated in FIG. 11 is one example thereof . The screen 1100 is a screen for an operator to deploy a desired application in a desired sight. On the screen 1100, a list of applications that can be selected, a list of sites that can be selected, an execution button, and a cancel button are displayed. When the execution button is clicked in a state in which a certain application and a certain site are selected, a message screen relating deployment thereof is displayed in the form of pop-up. When a Yes button is clicked on the message screen by the operator, deployment is actually performed.

The operating portal 401 displays various screens accompanying various processes other than this. For example, a screen for accepting execution instruction of prediction of processing performance of software using a prediction model and presenting a result thereof may be displayed.

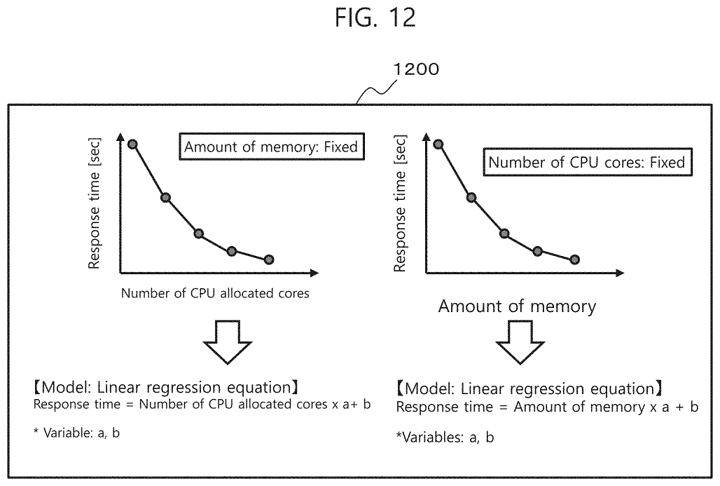

FIG. 12 is a diagram illustrating an overview of a prediction model that is assumed in the first embodiment. In FIG. 12, a graph representing a relation between the number of CPU cores and a response time acquired in a case in which the amount of memory is fixed and a graph representing a relation between the amount of memory and a response time acquired in a case in which the number of CPU cores is fixed are illustrated.

In this embodiment, it is assumed that there is a linear correlation between an amount of resources, that is, the number of CPU cores and an amount of memory allocated to a container that is a deployment designation of software and processing performance, that is, a response time of software processing. Thus, as illustrated in FIG. 12, when the amount of memory is set to a fixed value, a relation between the number of CPU cores and the response time can be approximated as a straight line. In addition, when the number of CPU cores is set to a fixed value, a relation between the amount of memory and the response time can be approximated as a straight line. By determining a linear regression equation having the configuration information including the amount of resources as a descriptive variable and the processing performance as an objective variable through learning, a prediction model is generated.

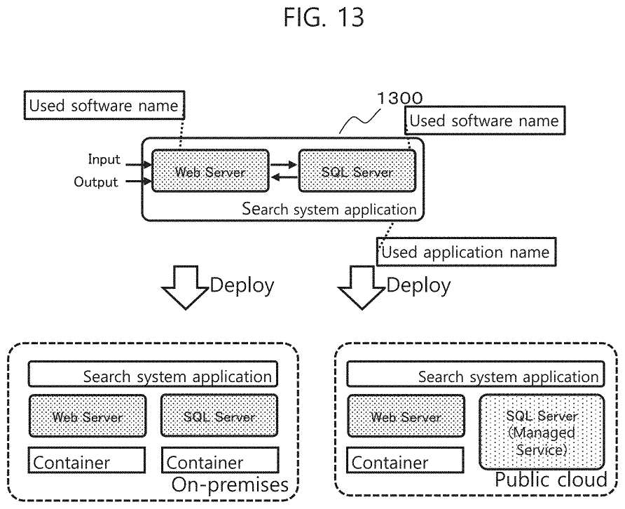

FIG. 13 is a diagram illustrating an overview of the application 207 assumed in the first embodiment.

In this embodiment, the application 207 is assumed to be a search system application as an example, and the search system application is assumed to be composed of software of a Web Server and software of a SQL Server. As a deployment configuration of the application 207 of such a configuration, the application can be deployed in a container in which both the Web Server and the SQL Server are built in the on-premises system 102. In addition, the software of the Web Server may be deployed in a container provided in the public cloud system 103, and the managed service 301 provided by the public cloud service provider may be used as the software of the SQL Server.

When a deployment configuration to be employed is determined, by predicting the processing performance of the software using the prediction model, an appropriate environment (site) and an appropriate amount of resources can be determined.

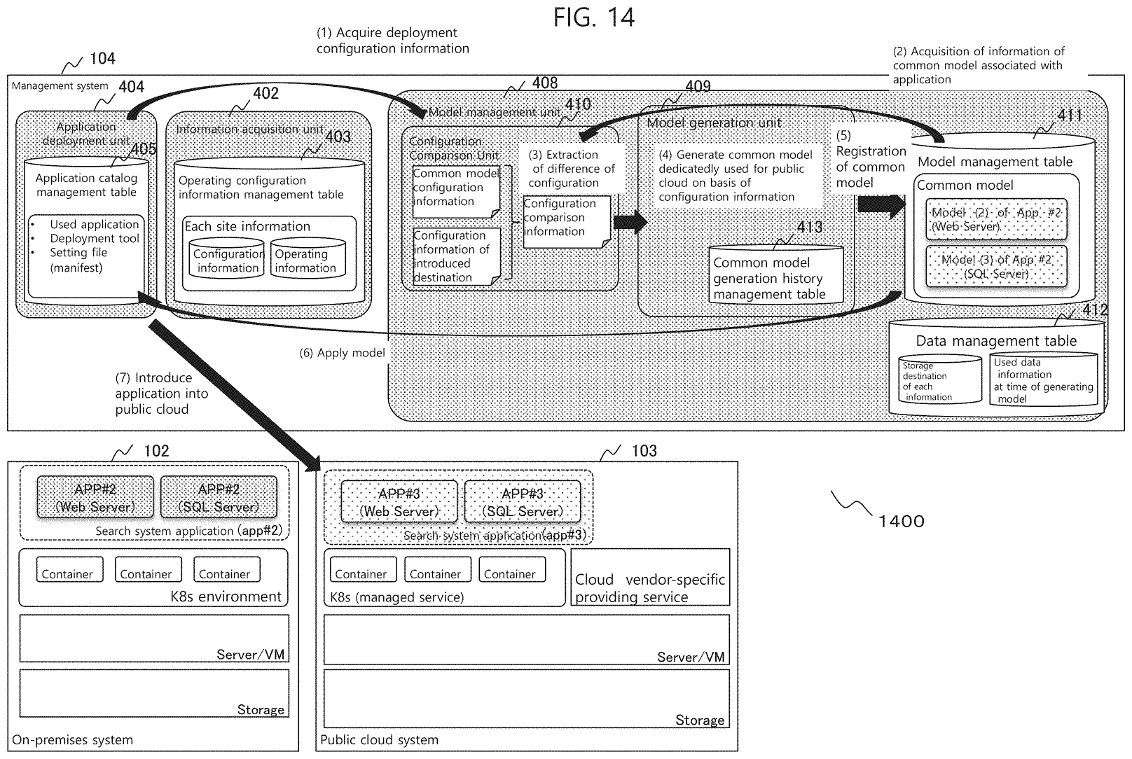

FIG. 14 is a diagram illustrating an overview of a process relating to commonization of a prediction model according to the first embodiment. In the conceptual diagram 1400 of FIG. 14, a series of processes (1) to (7) until actual deployment is performed, when a search system application APP#3 is deployed in a public cloud system 103, by using a prediction model that is generated and registered as a common model when a search system application APP#2 that has already been deployed in the on-premises system 102 is deployed, processing performance in the public cloud system 103 that is a candidate for a deployment destination of the search system application APP#3 is predicted and an appropriate amount of resources is determined on the basis of a result of the prediction, and are conceptually represented.

(1) The configuration comparison unit 410 acquires information of an application 207 that has already been deployed and an application 207 to be deployed from now.
(2) The configuration comparison unit 410 acquires information of a common model applied to the application 207, which has already been deployed, of the same type as that of the application 207 to be deployed from now.
(3) The configuration comparison unit 410 extracts a difference in the configuration information between the application 207 to be deployed from now and the application 207, which has already been deployed, of the same type.
(4) The model generation unit 409 generates a common model dedicatedly used for the public cloud system 103 by learning data in which the difference in the configuration information is taken into account.
(5) The model generation unit 409 registers the generated common model in the model management table 411.
(6) The application deployment unit 404 predicts processing performance of the search system application APP#3 on the public cloud system 103 using the common model.
(7) The application deployment unit 404 calculates a required amount of resources on the basis of a result of the prediction and deploys each piece of software of APP#3 in a container securing the amount of resources.

The series of processes will be described below in detail.

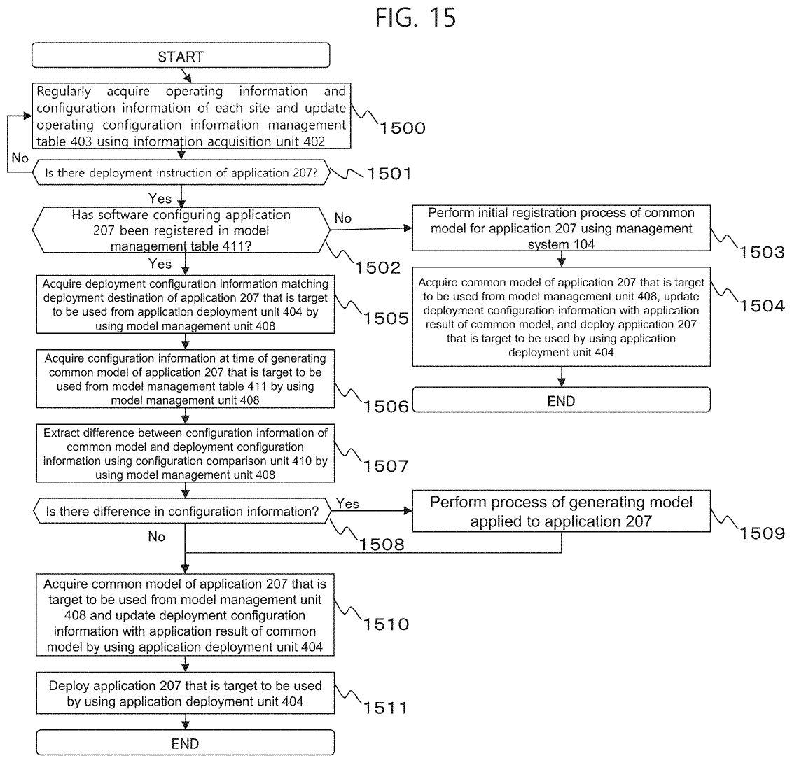

FIG. 15 is a flowchart illustrating a series of flows of a process relating to commonization of a prediction model according to the first embodiment.

In Step 1500, the information acquisition unit 402 regularly acquires operating information and configuration information of each site and updates the operating configuration information management table 403.

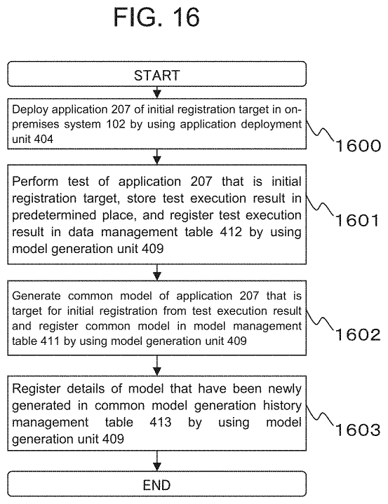

When there is an instruction indicating execution of deployment of the application 207 to be newly used (Yes in Step 1051), the model management unit 408 determines whether or not software configuring the application 207 has been registered in the model management table 411 in Step 1502. When the software configuring the application 207 has not been registered in the model management table 411, the management system 104 performs an initial registration process for a common model in Step 1503. The initial registration process for a common model is a process of initially registering a new common model. Details of the initial registration process for a common model will be described below with reference to FIG. 16.

Subsequently, in Step 1504, the application deployment unit 404 acquires a common model of the application 207 from the model management unit 408, calculates an amount of resources allocated to the application 207 by applying the common model to the application 207, updates the amount of resources with a manifest file (hereinafter also referred to as deployment configuration information) that is configuration information of the deployment configuration, performs deployment of the used application 207, and ends the process. In the deployment configuration information, configuration information of the application and information representing a site in which the software of the application is to be deployed and a prediction model is to be applied to the software may be included.

In Step 1502, when the software configuring the application 207 has been registered in the model management table 411, in Step 1505, the model management unit 408 acquires deployment configuration information matching a deployment destination of the application 207 that is a target to be used from the application deployment unit 404. The deployment configuration information matching a deployment destination of the application 207 that is a target to be used is deployment configuration information in which a site in which the application 207 that is a target to be used is to be deployed from now is set as a deployment destination. In this deployment configuration information, configuration information of the application 207 to be deployed from now is included.

Next, in Step 1506, the model management unit 408 acquires configuration information at the time of generating a common model of the application 207 that is a target to be used from the model management table 411.

Furthermore, in Step 1507, the model management unit 408 extracts a difference between the configuration information of the common model acquired in Step 1506 and the configuration information included in the deployment configuration information acquired in Step 1504 using the configuration comparison unit 410 and determines whether or not there is a difference between such pieces of the configuration information in Step 1508.

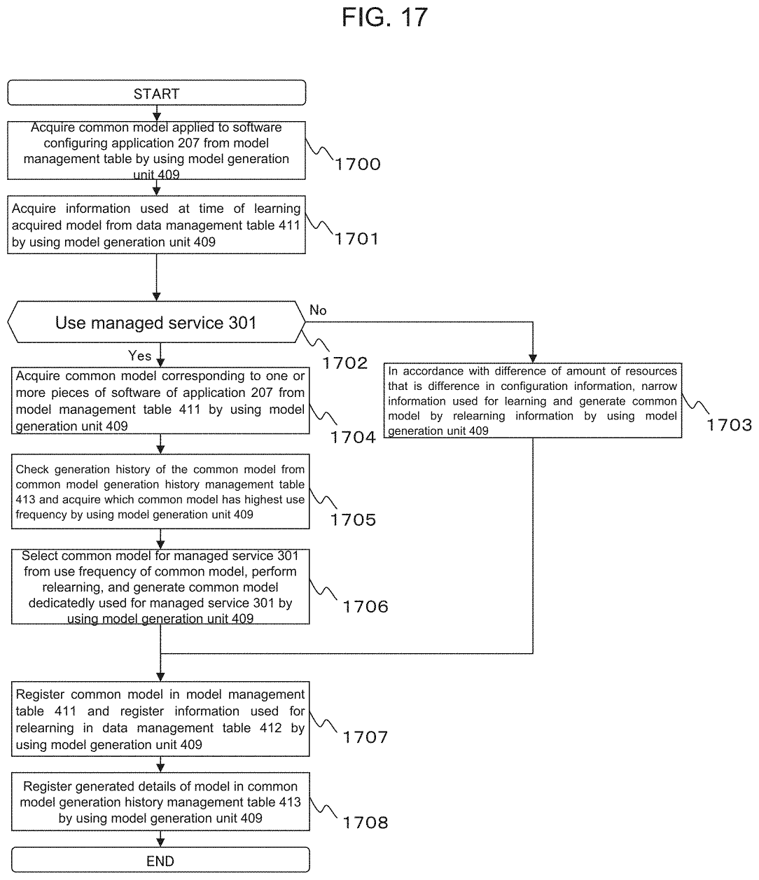

When there is a difference between such pieces of the configuration information (Yes in Step 1508) , the model management unit 408 performs a process of generating a model to be applied to the application 207 in Step 1509. The process of generating a model to be applied to the application 207 is a process of generating a prediction model used for predicting processing performance of software configuring the application 207. Details of the process of generating a model to be applied to the application 207 will be described below with reference to FIG. 17.

When there is no difference between the two pieces of the configuration information in Step 1508 (No in Step 1508) and when the process of Step 1509 ends, the application deployment unit 404, in Step 1510, acquires a common model of the application 207 that is a target to be used from the model management unit 408, calculates an amount of resources to be allocated to the application 207 by applying a common model to the application 207 that is a target to be used, and updates the deployment configuration information with the calculated amount of resources.

In addition, the application deployment unit 404 performs deployment of the application 207 that is a target to be used and ends the process.

FIG. 16 is a flowchart illustrating an initial registration process of a common model according to the first embodiment. This represents the process of Step 1603 in FIG. 15 in more detail.

In Step 1600, the application deployment unit 404 deploys the application 207 that is the initial registration target in the on-premises system 102.

Although the site in which the application 207 is to be deployed is the public cloud system 103, in this stage, first, the application 207 is deployed in the on-premises system 102.

Next, in Step 1601, the model generation unit 409 executes the application 207 that is a target for initial registration on the on-premises system 102 as a test and stores data representing a test execution result acquired by the test execution in a predetermined place. Management information of the data is registered in the data management table 412. For example, the test execution is measuring processing performance that is a processing time while changing an amount of resources that are the number of CPU cores and the amount of memory.

Next, in Step 1602, the model generation unit 409 performs learning using the test execution result as learning data, generates a common model of the application 207 that is the target for the initial registration, and registers the generated common model in the model management table 411. For example, the common model described here is a regression equation. Furthermore, in Step 1603, the model generation unit 409 registers details of the generated common model in the common model generation history management table 413.

FIG. 17 is a flowchart illustrating a model generation process applied to an application 207 according to the first embodiment. This represents the process of Step 1509 in FIG. 15 in more detail.

In Step 1700, the model generation unit 409 acquires a common model applied to software configuring the application 207 from the model management table 411. Subsequently, in Step 1701, the model generation unit 409 acquires information used at the time of learning the acquired common model from the data management table 412.

Next, in Step 1702, the model generation unit 409 determines whether or not the application 207 to be deployed uses the managed service 301 in the public cloud system 103. For example, whether or not the managed service 301 is used may allow an operator to acquire an input of the determination from the operating portal 401. Ina case in which it is determined that the managed service 301 is not used (No in Step 1702), in Step 1703, the model generation unit 409 generates a prediction model through learning using the configuration information to which the difference of the configuration information extracted in Step 1507 is added and sets the prediction model as a common model.

Although learning using the configuration information to which the difference of the configuration information is added is not particularly limited, a difference between amounts of resources included in the configuration information may be reflected in the processing performance using a predetermined conversion equation.

For example, a conversion may be performed by assuming that, when the number of CPU cores become twice, the processing time becomes ½. In addition, for example, in a case in which a common model for predicting processing performance in a case in which software is deployed in the public cloud system 103 using the managed service 301 is generated on the basis of the common model generated in a case in which the software is deployed in the on-premises system 102, for example, an amount of resources in the on-premises system 102 and an amount of resources in the managed service 301 of the public cloud system 103 maybe converted using a predetermined conversion equation and used for learning.

In addition, in a case in which the range of the amount of resources in the configuration information used for learning at the time of generating an existing common model is wider than the range that can be taken by the amount of resources in the deployment destination of software to which a new common model is applied, the configuration information at the time of generating the existing common model may be used for learning by being limited to the range that can be taken by the amount of resources in the deployment destination of the software to which the new common model is applied. By narrowing the configuration information at the time of generating an existing common model to configuration information of which a value of the amount of resources is within a range that can be taken by the amount of resources in the deployment destination of new software, and the narrowed configuration information may be used for learning. Here, the model generation unit 409 narrows information used for learning with a difference in the amount of resources corresponding to the difference of the configuration information extracted in Step 1507 taken into account, performs relearning using the narrowed information, and sets a generated prediction model as the common model.

In Step 1702, in a case in which the managed service 301 is determined to be used (Yes in Step 1702), the model generation unit 409 acquires common models associated with software configuring the application 207 from the model management table 411 in Step 1704.

Next, in Step 1705, the model generation unit 409 calculates use frequencies of the common models extracted in Step 1704 by referring to a generation history of the common model in the common model generation history management table 413.

Subsequently, in Step 1706, the model generation unit 409 selects one of the common models extracted in Step 1704 on the basis of the use frequency, acquires information of the selected common model, generates a prediction model by relearning the acquired information, and generates a common model dedicatedly used for the managed service 301 in the application 207 to be deployed from now using the generated prediction model. Here, selection of a common model on the basis of the use frequency means that, since a common model applied to software using the managed service 301 is not present yet, a common model of which the use frequency is high among the common models applied to the software deployed in another environment (the on-premises system 102) is used. In addition, the use frequency of the common model may be weighted on the basis of a deployment destination of the software to which the common model is applied, whether it is used as a countermeasure at the time of changing the amount of resources, or the like. The common model dedicatedly used for the managed service 301 represents a prediction model that is used for predicting processing performance of the managed service 301 and is set as a common model.

After performing the process of Step 1703 or after performing the process of Step 1706, in Step 1707, the model generation unit 409 registers the generated common model in the model management table 411 and registers the information used for relearning in the data management table 412. Furthermore, in Step 1708, the model generation unit 409 registers details of the generated common model in the common model generation history management table 413.

### Second Embodiment

According to a second embodiment, a management system 104 performs reorganization and update of common models, which is different from the first embodiment. In the second embodiment, the configuration of a hybrid cloud is similar to that according to the first embodiment illustrated in FIG. 1 . In addition, an edge system 101, an on-premises system 102, and a public cloud system 103 according to the second embodiment are similar to those illustrated in FIG. 2 or 3. Furthermore, the management system 104 according to the second embodiment has a basic configuration similar to that according to the first embodiment illustrated in FIG. 4, and a process performed is different from that according to the first embodiment. Hereinafter, in the second embodiment, parts different from the first embodiment will be mainly described.

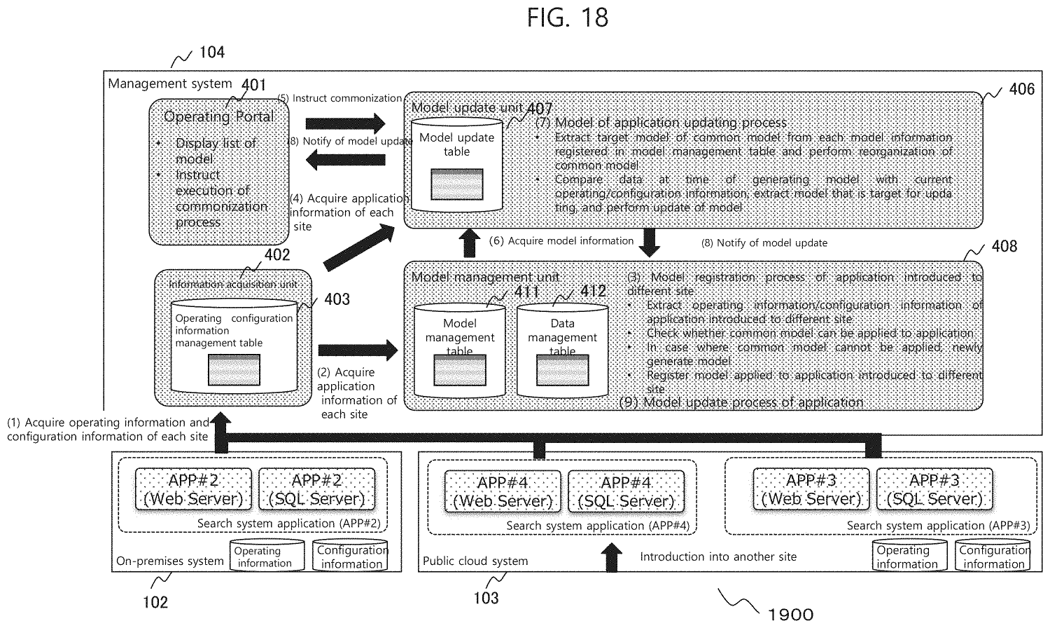

FIG. 18 is a diagram illustrating an overview of a process relating to commonization of a model according to the second embodiment. In the conceptual diagram 1900 of FIG. 18, for common models applied to search system applications APP #2 to #4 deployed in the on-premises system 102 and public cloud system 103, the flow of a series of processes including a reorganization process of reorganizing a plurality of common models into one and an update process of updating each common model through learning using new information are conceptually represented by (1) to (9).

(1) An information acquisition unit 402 collects operating information and configuration information of an application 207 introduced into each site.
(2) A model management unit 408 acquires application information (operating information and configuration information) of each site from the information acquisition unit 402.
(3) A model management unit 408, when an application 207 introduced into another site is newly registered, extracts operating information and configuration information thereof. Furthermore, in a case in which an existing common model can be applied to software of the application, the model management unit 408 applies the existing common model. For example, in a case in which the existing common model is applied to pieces of the same-type software, the existing common model can be applied to new software. Ina case in which the existing common model cannot be applied to new software, the model management unit 408 generates a prediction model by newly performing learning, and checks that a sufficient prediction result can be acquired using the prediction model, and then sets the generated prediction model as a common model.
(4) A model update unit 406 also acquires application information of each site.
(5) A commonization instruction is given to the model update unit 406 in accordance with an operation input to an operating portal.
(6) The model update unit 406 acquires model information of each prediction model including the existing common model from the model management unit 408. Information of software to which a corresponding prediction model applied is included in the model information.
(7) The model update unit 406 extracts prediction models that can apply a common model to software that is a target to be applied on the basis of the model information and performs reorganization for the common model. The reorganization for the common model represents that the common model is applied to software to which a certain prediction model has been applied originally, and the original prediction model is discarded. In addition, the model update unit 406 extracts software of the application 207 of which operating information or configuration information is changing on the basis of the model information and updates a prediction model applied to the software.
(8) The model update unit 406 notifies the model management unit 408 of the common model having been updated.
(9) The model management unit 408 registers the updated common model on the basis of the notification.

A series of these processes will be described in more detail below.

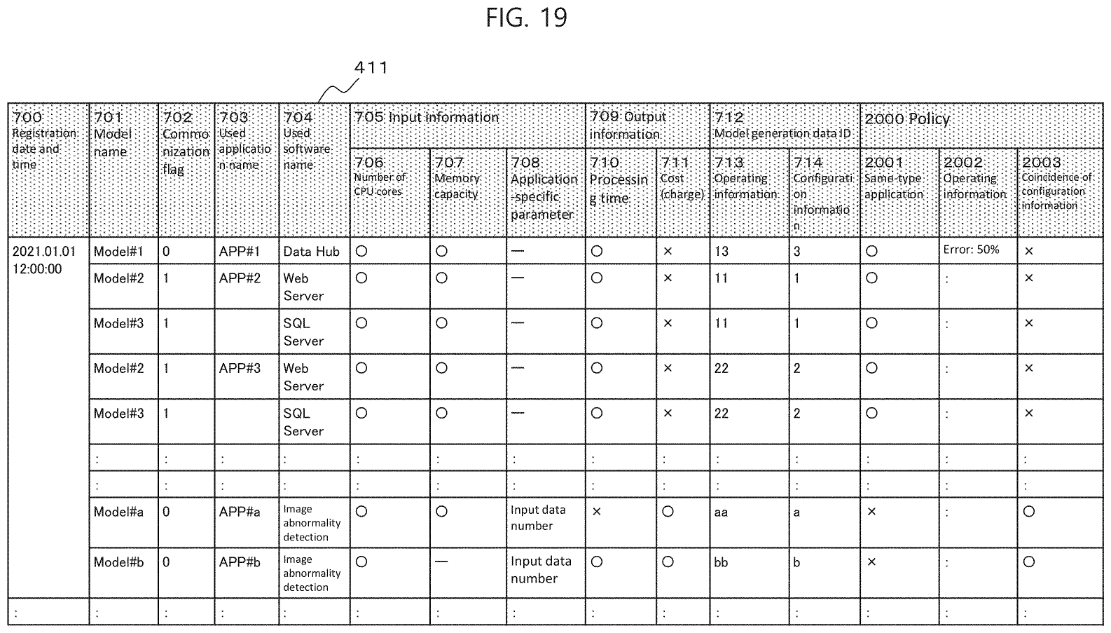

FIG. 19 is a diagram illustrating a configuration example of a model management table 411 according to the second embodiment. Referring to FIG. 19, the model management table 411 according to the second embodiment is different from the model management table 411 according to the first embodiment illustrated in FIG. 7 in that a policy 2000 is registered in a prediction model. The policy 2000 is a policy relating to commonization of a prediction model and is information that defines software and an environment to which a prediction model can be applied. The policy 2000 includes a same-type application 2001, operating information 2002, and coincidence of configuration information 2003. The same-type application 2001 is information indicating whether or not software needs to be software configuring an application of the same type as an associated application for being able to apply the prediction model. The operating information 2002 is information indicating whether a difference in the operating information 2002 from an associated application needs to be up to a certain degree for being able to apply the prediction model. The coincidence of configuration information 2003 is information indicating whether or not coincidence with the configuration of the associated application is necessary for being able to apply the prediction model.

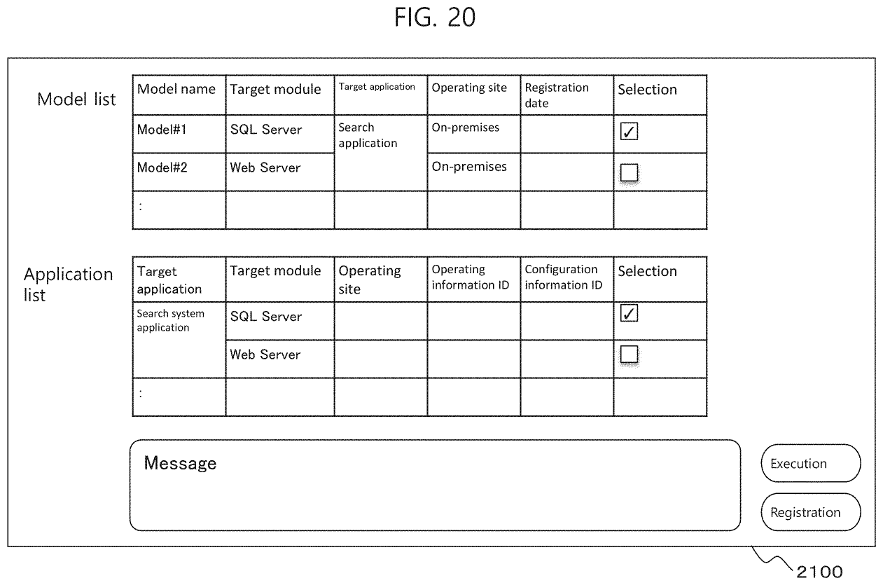

FIG. 20 is a diagram illustrating a configuration example of a screen of the operating portal 401 according to the second embodiment. The screen 2100 of the operating portal is a screen that accepts an operation for performing a commonization process of prediction models. The screen 2100 includes a display of a list of prediction models, a display of a list of applications 207, an execution button, a registration button, and a message display area. From the display of the list of prediction models, prediction models to be targets for a commonization process can be individually selected. From the display of the list of applications 207, applications 207 to be applied as prediction models that are targets for a commonization process and prediction models corresponding to conditions relating to software can be selected together. When the execution button is clicked, the commonization process of the prediction models is performed. When the registration button is clocked, a result of the commonization process of prediction models is registered. In the message display area, a message for an operator is display accompanying acceptance of an operation, execution of a process, and the like.

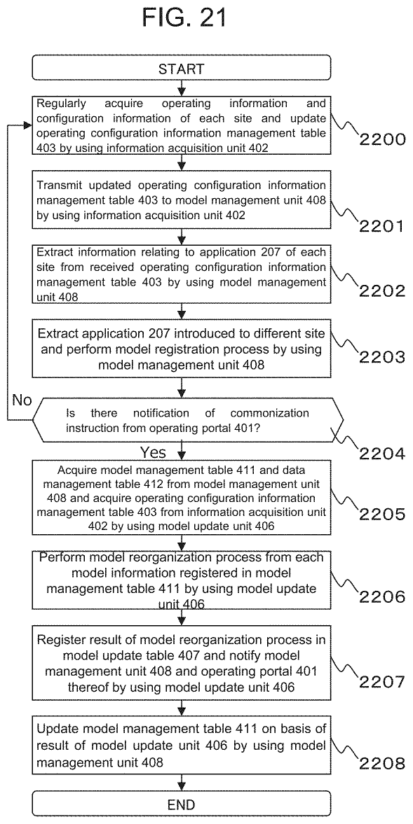

FIG. 21 is a flowchart illustrating a series of flows of a commonization process of prediction models according to the second embodiment.

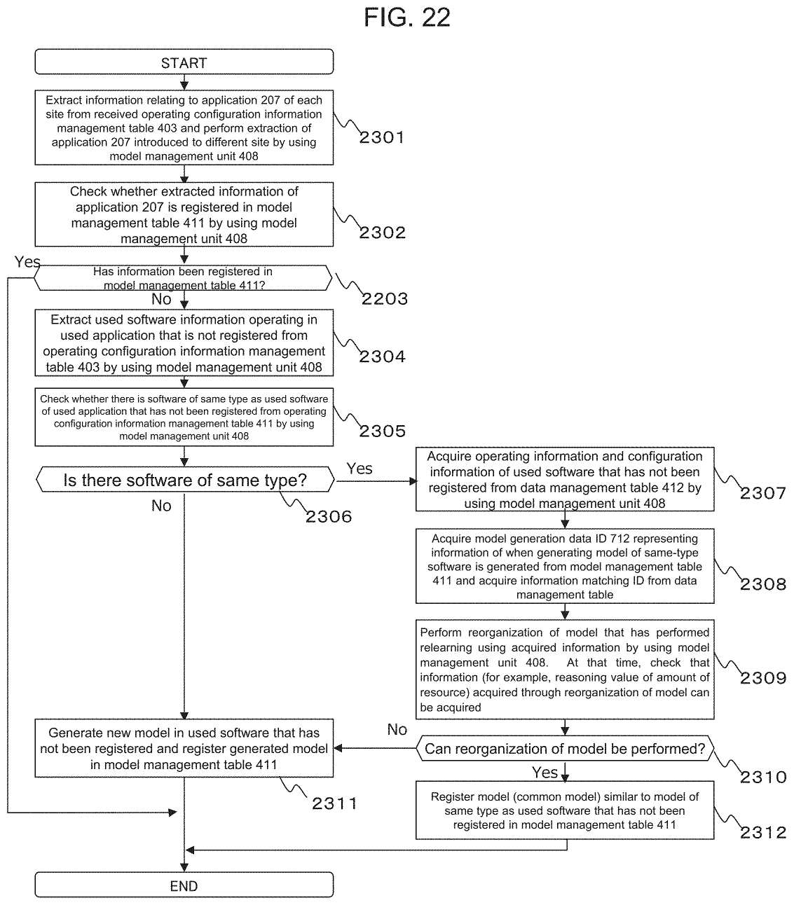

Until an operation indicating execution of commonization is accepted in the operating portal 401, the management system 104 regularly repeatedly performs processes of Steps 2200 to 2204. In Step 2200, the information acquisition unit 402 regularly acquires operating information and configuration information of each site and updates the operating configuration information management table 403 with the acquired information. In Step 2201, the information acquisition unit 402 transmits the updated operating configuration information management table 403 to the model management unit 408. In Step 2202, the model management unit 408 receives the operating configuration information management table 403 from the information acquisition unit 402 and extracts information relating to an application 207 of each site from the operating configuration information management table 403. In Step 2203, the model management unit 408 extracts an application 207 that has been newly introduced to another site and, when there is an application 207 that has been newly introduced to the other site, performs a model registration process for the application 207. The model registration process is a process of registering a prediction model to be applied for software of which a prediction model to be applied has not been registered. Details of the model registration process will be described below with reference to FIG. 22.

In Step 2204, the management system 104 determines whether or not an instruction indicating execution of a commonization process of prediction models has been accepted using the operating portal 401. When the instruction has not been accepted (No in Step 2204), the management system 104 returns the process to Step 2200 and repeats the process.

On the other hand, when an instruction indicating execution of a commonization process of prediction models has been accepted using the operating portal 401 (Yes in Step 2204), in Step 2205, the model update unit 406 acquires the model management table 411 and the data management table 412 from the model management unit 408 and acquires the operating configuration information management table 403 from the information acquisition unit 402.

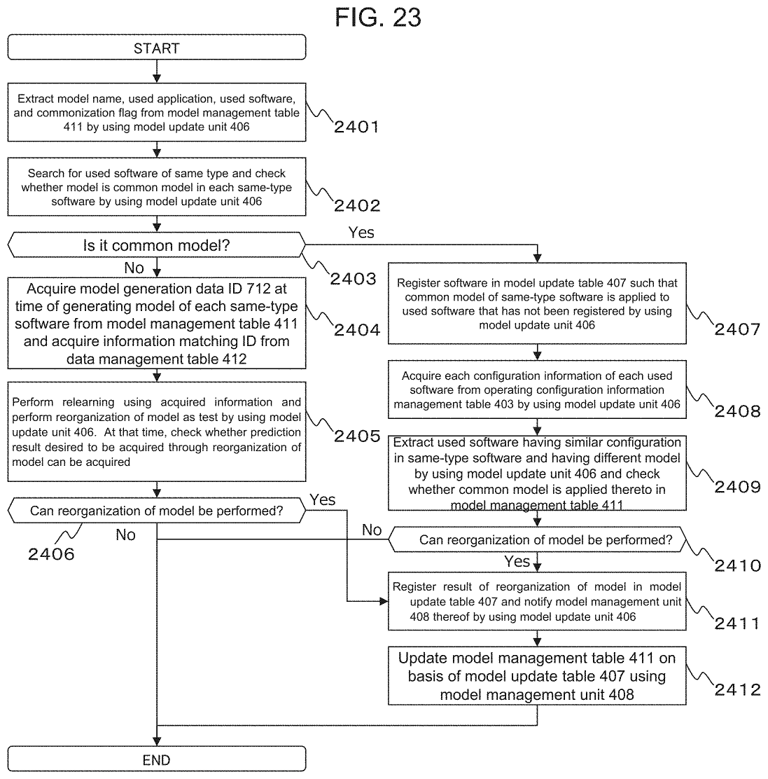

Next, the model update unit 406 performs a model reorganization process on the basis of each piece of model information registered in the model management table 411 in Step 2206. The model reorganization process is a process in which, in a case in which there are a plurality of pieces of software to which different prediction models are currently applied but the same common model can be applied, the common models applied to the software is integrated into one common model. Details of the model integration process will be described below with reference to FIG. 23.

Next, in Step 2207, the model update unit 406 registers a result of the model reorganization process in the model update table 407 and notifies of the model management unit 408 and the operating portal 401 of the result. In the operating portal 401, a screen presenting the result of the model reorganization process to an operator is displayed. In Step 2208, the model management unit 408 updates the model management table 411 on the basis of the result of the model reorganization process notified from the model update unit 406 and ends a series of processes.

FIG. 22 is a flowchart illustrating a model registration process according to the second embodiment. This process is a detailed process of Step 2203 illustrated in FIG. 21.

Step 2301 is a process corresponding to Steps 2201 to 2202 illustrated in FIG. 21. In Step 2301, the model management unit 408 extracts information relating to the application 207 of each site from the operating configuration information management table 403 received from the information acquisition unit 402 and extraction of applications 207 introduced to other sites.

The model management unit 408 checks whether or not the extracted information of the application 207 is registered in the model management table 411 in Step 2302 and determines whether or not the information of the application 207 is registered in the model management table 411 in Step 2303. When the extracted application 207 is registered in the model management table 411, the model registration process ends.

When the information of the application 207 is determined not to be registered in the model management table 411 in Step 2303, the model management unit 408 extracts information relating to software (hereinafter also referred to as “used software”) configuring the application that has not been registered (hereinafter also referred to as an “used application”) from the operating configuration information management table 403 in Step 2304.

Furthermore, the model management unit 408 checks whether or not a prediction model applied to the same-type software as the used software configuring the used application that has not been registered (hereinafter referred to as “same-type software”) is registered in the model management table 411 in Step 2305 and determines whether or not the prediction model applied to the same-type software is registered in the model management table 411 in Step 2306. Here, although an example in which a prediction model applied to the same-type software is set as a target has been illustrated, as another example, a prediction model applied to software satisfying the policy 2000 may be set as a target.

When the prediction model applied to the same-type software is registered in the model management table 411, the model management unit 408 acquires operating information and configuration information of the used software from the data management table 412 in Step 2307. Furthermore, in Step 2308, the model management unit 408 acquires a model generation data ID 712 representing information at the time of generating a prediction model applicated to the same-type software from the model management table 411 and acquires operating information and configuration information corresponding to the ID from the data management table 412.

Next, in Step 2309, the model management unit 408 performs relearning by composing the operating information and the configuration information acquired in Step 2307 and Step 2308 and generates a new prediction model. The new prediction model generated here can be applied to both the used software and the same-type software. Thus, the model management unit 408 checks that desired information of both the used software and the same-type software can be acquired by applying the new prediction model. The desired information is an appropriate prediction result of processing performance acquired using the prediction model. For example, the desired information is an appropriate prediction value of a required amount of resources.

In Step 2310, the model management unit 408 determines whether or not common models of the used software and the same-type software can be reorganized. It is determined that the reorganization can be performed in a case in which desired information can be acquired for the used software and the same-type software using the prediction model generated in Step 2309, and it is determined that reorganization cannot be performed in a case in which desired information can be acquired for one or both of the used software and the same-type software using the prediction model.

When it is determined that the reorganization can be performed (Yes in Step 2310), the model management unit 408 registers that new common model that is the same as the same-type model is applied to the used software in the model management table 411 in Step 2312. On the other hand, when it is determined that the reorganization cannot be performed (No in Step 2310), the model management unit 408 newly generates a prediction model for the used software and registers the generated prediction model in the model management table 411 in Step 2311.

FIG. 23 is a flowchart illustrating a model reorganization process according to the second embodiment. The model reorganization process is a process of reorganizing common models in accordance with an instruction accepted in the operating portal 401. This process is a detailed process of Step 2206 illustrated in FIG. 21.

In Step 2401, the model update unit 406 extracts a model name 701, a used application name 703, a used software name 704, and a commonization flag 702 from the model management table 411 acquired in Step 2205.

In Step 2402, the model update unit 406 searches same-type software on the basis of the information extracted in Step 2401 and checks whether or not a common model is applied to the same type software that have been retrieved. In Step 2403, the model update unit 406 determines whether or not a common model is applied to the same-type software.

When a common model is not applied to the same-type software (No in Step 2403), the model update unit 406, in Step 2404, acquires model generation data IDs 712 used when prediction models applied to the same-type software are generated from the model management table 411, acquires the configuration information 804 and the operating information 808 matching the IDs from the data management table 412, and integrates the acquired information.

Next, in Step 2405, the model update unit 406 learns the configuration information 804 and the operating information 808 that have been integrated in Step 2404, thereby generating a prediction model that can be applied to the software. Furthermore, it is checked whether an appropriate prediction result can be acquired by applying the prediction model generated here to the software. For example, the appropriate prediction result is an appropriate prediction value of an amount of required resources.

Then, in Step 2406, the model update unit 406 determines whether or not prediction models can be reorganized. It is determined that the reorganization can be performed in a case in which an appropriate prediction result can be acquired for the software of the same-type using the prediction model generated in Step 2405, and it is determined that reorganization cannot be performed in a case in which an appropriate prediction result cannot be acquired for any one piece of the software of the same-type using the prediction model. When it is determined that the reorganization of the prediction models cannot be performed (No in Step 2406), the model update unit 406 ends the process without reorganizing the prediction models applied to the same-type software.

When a common model is applied to the same-type software in Step 2403 (Yes in Step 2403), the model update unit 406 performs registration for the model update table 407 such that the common model applied to the same-type software is applied to software not registered in the model update table 407 in Step 2407.

In Step 2408, the model update unit 406 acquires configuration information of each piece of same-type software from the operating configuration information management table 403.

In Step 2409, the model update unit 406 extracts same-type software which has a similar configuration and for which applied prediction models are different and checks whether or not a prediction model applied to the software is a common model by referring to the commonization flag 702 of the model management table 411.

In Step 2410, the model update unit 406 determines whether or not the prediction models can be reorganized. In Step 2409, in a case in which the same common model is not applied to the same-type software having a similar configuration, it is determined that the prediction models applied to such software can be reorganized. In that case, by applying to such software a common model in which any one piece of the software is applied, the prediction models can be reorganized. On the other hand, in a case in which the same common model has already been applied to the same-type software having a similar configuration, it is determined that the prediction models applied to the software cannot be reorganized. In a case in which it is determined that the prediction models cannot be reorganized (No in Step 2410), the model update unit 406 ends the process without reorganizing the prediction models applied to the software.

In a case in which it is determined that the prediction models can be reorganized in Step 2406 (Yes in Step 2406) and in a case in which it is determined that the prediction models can be reorganized in Step 2410 (Yes in Step 2410) , the model update unit 406, in Step 2411, registers a result of the reorganization of the prediction models in the model update table 407 and notifies the model management unit 408 of an indication of registration of new information in the model update table 407. In Step 2412, the model management unit 408 updates the model management table 411 on the basis of the model update table 407.

The embodiments described above include the following items. However, items included in the embodiments described above are not limited to the items represented below.

Item 1

A model management system managing a prediction model for predicting processing performance of software configuring an application in a deployment destination, the model management system including: a model management table configured to store a first common model that is a prediction model able to be commonly used for prediction of processing performance of software of a same type; a data management table configured to store first configuration information representing a configuration of a deployment destination of software used for learning when the first common model is generated; a configuration comparison unit configured to extract a difference between second configuration information representing a configuration of a deployment destination of target software, which is a prediction target, and the first configuration information; and a model generation unit configured to generate a prediction model through learning using configuration information that is acquired by adding the difference to the first configuration information and set the prediction model as a second common model that is a new common model.

In this way, a common model that can be commonly used for predicting processing performance of software of the same type is prepared in advance, and a new common model is generated by adding a difference in the configuration between a deployment destination at the time of generation of the common model and a deployment destination of the target software. For this reason, according to appropriate learning in which commonization of prediction models and the difference are taken into account, prediction models for evaluating processing performance of software can be efficiently managed.

Item 2

The model management system according to Item 1, in which, when the first common model is generated, a deployment destination of software, of which processing performance is predicted using the common model, is a computer of on-premises, and a deployment destination of the target software is a computer of a public cloud.

Item 3

The model management system according to Item 2, in which the prediction model is a regression equation that calculates an objective variable representing processing performance of an arithmetic operation process on the basis of a descriptive variable relating to an amount of resources provided for the arithmetic operation process.

In this way, processing performance is predicted using a regression equation, and thus the base of a prediction result is clear, and an area for which learning data is not sufficient can be predicted as well.

Item 4

The model management system according to Item 3, in which, in a case in which a range of an amount of resources included in the first configuration information is wider than a range that can be taken by the amount of resources included in the second configuration information, the configuration comparison unit restricts the first configuration information to the range of the amount of resources included in the second configuration information and extracts a difference between the second configuration information and the restricted first configuration information, and the model generation unit generates the second common model on the basis of the restricted first configuration information and the difference extracted by restricting the first configuration information.

According to this, by performing learning with learning data narrowed to a necessary range, a common model having a high prediction accuracy in the necessary range can be generated.

Item 5

The model management system according to Item 2, in which, in a case in which the computer of the public cloud provides a unique service that is a unique computing service not provided by the computer of the on-premises, and the target software is deployed in the public cloud using the unique service, the model generation unit generates a second common model that can be used for predicting processing performance of the target software using the unique service in the computer of the public cloud on the basis of the first common model that can be used for predicting processing performance of software of the same type as that of the target software in the computer of the on-premises.

In this way, also in a case in which target software is deployed using a unique service of a public cloud, the common model can be generated on the basis of the common model of the on-premises.

Item 6

The model management system according to Item 1, further including: a model management unit configured to manage prediction models including the common model generated by the model generation unit and software, of which processing performance is predicted using the prediction model, in association with each other; and a model update unit configured to, when a plurality of different prediction models are used for predicting processing performance of a plurality of pieces of software of the same type during management using the model management unit, generate a new prediction model by relearning data at the time of generation of the plurality of prediction models and, when the processing performance of the plurality of pieces of software are predicted correctly using the new prediction model, set the new prediction model as a common model for the plurality of pieces of software.

In this way, by reorganizing common models, management of the prediction models can be easily performed.

Item 7

The model management system according to Item 6, in which, when different common models are used for predicting processing performance of a plurality of pieces of software of the same type of which configurations of the deployment destinations are the same during management using the model management unit, the model update unit sets any one of the common models as a common model for the plurality of pieces of software.

In this way, by reorganizing common models, management of prediction models can be easily performed.

Item 8

The model management system according to Item 1, in which, when the common model is generated, a deployment destination of software of which processing performance is predicted using the common model is a computer of a public cloud, and the deployment destination of the target software is a computer of on-premises.

The embodiments of the present invention described above are merely examples for describing the present invention and are not for the purpose of limiting the scope of the present invention to only such embodiments. A person skilled in the art can perform the prevent invention in various forms without departing from the scope of the present invention.

What is claimed is:

1. A model management system managing a prediction model for predicting processing performance of software configuring an application in a deployment destination, the model management system comprising:
a model management table configured to store a first common model that is a prediction model able to be commonly used for prediction of processing performance of software of a same type;
a data management table configured to store first configuration information representing a configuration of a deployment destination of software used for learning when the first common model is generated;
a configuration comparison unit configured to extract a difference between second configuration information representing a configuration of a deployment destination of target software, which is a prediction target, and the first configuration information; and
a model generation unit configured to generate a prediction model through learning using configuration information that is acquired by adding the difference to the first configuration information and set the prediction model as a second common model that is a new common model.

2. The model management system according to claim 1,
wherein, when the first common model is generated, a deployment destination of software, of which processing performance is predicted using the common model, is a computer of on-premises, and
wherein a deployment destination of the target software is a computer of a public cloud.

3. The model management system according to claim 2, wherein the prediction model is a regression equation that calculates an objective variable representing processing performance of an arithmetic operation process on the basis of a descriptive variable relating to an amount of resources provided for the arithmetic operation process.

4. The model management system according to claim 3,
wherein, in a case in which a range of an amount of resources included in the first configuration information is wider than a range that can be taken by the amount of resources included in the second configuration information, the configuration comparison unit restricts the first configuration information to the range of the amount of resources included in the second configuration information and extracts a difference between the second configuration information and the restricted first configuration information, and
wherein the model generation unit generates the second common model on the basis of the restricted first configuration information and the difference extracted by restricting the first configuration information.

5. The model management system according to claim 2, wherein, in a case in which the computer of the public cloud provides a unique service that is a unique computing service not provided by the computer of the on-premises, and the target software is deployed in the public cloud using the unique service, the model generation unit generates a second common model that can be used for predicting processing performance of the target software using the unique service in the computer of the public cloud on the basis of the first common model that can be used for predicting processing performance of software of the same type as that of the target software in the computer of the on-premises.

6. The model management system according to claim 1, further comprising:
a model management unit configured to manage prediction models including the common model generated by the model generation unit and software, of which processing performance is predicted using the prediction model, in association with each other; and
a model update unit configured to, when different prediction models are used for predicting processing performance of a plurality of pieces of software of the same type during management using the model management unit, generate a new prediction model by relearning data at the time of generation of the plurality of prediction models and, when the processing performance of the plurality of pieces of software are predicted correctly using the new prediction model, set the new prediction model as a common model for the plurality of pieces of software.

7. The model management system according to claim 6, wherein, when different common models are used for predicting processing performance of a plurality of pieces of software of the same type of which configurations of the deployment destinations are the same during management using the model management unit, the model update unit sets any one of the common models as a common model for the plurality of pieces of software.

8. The model management system according to claim 1,
wherein, when the common model is generated, a deployment destination of software of which processing performance is predicted using the common model is a computer of a public cloud, and
wherein the deployment destination of the target software is a computer of on-premises.

9. A model management method for managing a prediction model for predicting processing performance of software configuring an application in a deployment destination, the model management method executed by a computer and comprising:
storing a first common model that is a prediction model able to be commonly used for prediction of processing performance of software of a same type;
storing first configuration information representing a configuration of a deployment destination of software used for learning when the first common model is generated;
extracting a difference between second configuration information representing a configuration of a deployment destination of target software, which is a prediction target, and the first configuration information; and
generating a prediction model through learning using configuration information that is acquired by adding the difference to the first configuration information and setting the prediction model as a second common model that is a new common model.

10. A storage medium readable by an information processing apparatus and storing a model management program for managing a prediction model for predicting processing performance of software configuring an application in a deployment destination, the storage medium storing the model management program causing a computer to perform:
storing a first common model that is a prediction model able to be commonly used for prediction of processing performance of software of a same type;
storing first configuration information representing a configuration of a deployment destination of software used for learning when the first common model is generated;
extracting a difference between second configuration information representing a configuration of a deployment destination of target software, which is a prediction target, and the first configuration information; and
generating a prediction model through learning using configuration information that is acquired by adding the difference to the first configuration information and setting the prediction model as a second common model that is a new common model.
